(19) United States
(12) Patent Application Publication
(10) Pub. No.: US 2023/0304640 A1
(43) Pub. Date: Sep. 28, 2023

(54) SOLAR PANEL AND BATTERY WITH SPLITTER FOR DOUBLE ELECTRICAL CABLE OUTPUT THEREFROM

(71) Applicant: LES PRODUITS SUNFORCE INC., Montreal-Ouest (CA)

(72) Inventors: Simon BAILEY, Montreal (CA); Michael DAHAN, Hampstead (CA)

(21) Appl. No.: 18/127,476

(22) Filed: Mar. 28, 2023

Related U.S. Application Data
(60) Provisional application No. 63/324,237, filed on Mar. 28, 2022.

(51) Int. Cl. F21S 9/03; H01R 11/32; H01R 13/443; H01R 13/66; H02S 40/34; F21V 23/06

(52) U.S. Cl. CPC F21S 9/032; F21V 23/06; H01R 11/32; H01R 13/443; H01R 13/6641; H02S 40/34

(57) ABSTRACT

A solar light system may include a solar panel module adapted for converting solar light into electric power. The solar light system may include a splitter cable adapted for connecting electrically and mechanically to the solar panel module, the splitter cable comprising a main power cable connecting to the solar panel module, and at least two downstream cables coupled to the main power cable, each comprising a connection terminal adapted for connecting electrically and mechanically to a lighting device to be powered therethrough, wherein the connection terminals feature a securing part designed for interfacing with a coupling component into a weatherproof connection.

### CROSS-REFERENCE TO RELATED APPLICATION

This application claims benefit from U.S. Pat. application 63/324,237, filed Mar. 28, 2022, the specification of which is hereby incorporated herein by reference in its entirety.

### BACKGROUND

### (A) Field

The subject matter disclosed generally relates to lighting and more particularly exterior lighting. More particularly, the subject matter disclosed relates to exterior lighting powered by solar panels and components thereof.

### (B) Related Prior Art

In the field of exterior lighting, lighting is an integral part of the ambiance. However, connection to the grid is not always easy to reach, and sometimes involves lengthy power cords extending all over the place.

Solar lighting devices need to be designed to resist to weather conditions such as wind, rain and direct sun that may generate premature wear.

Furthermore, as the solar panel technologies and the light emitting technologies develop, the ratio of solar panel required per light emitting device decreases.

There is therefore a need for improvement in the field of solar-powered lighting devices that respond to these drawbacks.

### SUMMARY

In some aspects, the techniques described herein relate to a solar lighting system including: a solar panel module adapted for converting solar light into electric power; a splitter cable electrically and mechanically connected to the solar panel module, the splitter cable including a main power cable connecting to the solar panel module, and at least two downstream cables coupled to the main power cable, each including a connection terminal adapted for connecting electrically and mechanically to a lighting device to be powered therethrough, wherein the connection terminals feature a securing part designed for interfacing with a coupling component into a weatherproof connection.

In some aspects, the techniques described herein relate to a solar lighting system, wherein the splitter cable is permanently connected to the solar panel module.

In some aspects, the techniques described herein relate to a solar lighting system, wherein the main power cable of the splitter cable includes a powering connection terminal.

In some aspects, the techniques described herein relate to a solar light system, wherein the connection terminals of the downstream cables are load connection terminals, and wherein the powering connection terminal is distinct and different from the load connection terminals.

In some aspects, the techniques described herein relate to a solar light system, further including the lighting device, the lighting device including a connection terminal that can be secured to one of the connection terminals to connect electrically and mechanically the lighting device to the solar panel module.

In some aspects, the techniques described herein relate to a solar light system, further including a plug cap securable to the connection terminals to weatherproof the connection terminal therethrough.

In some aspects, the techniques described herein relate to a solar light system, wherein the connection terminal and the plug cap include complementary threads.

In some aspects, the techniques described herein relate to a solar light system, wherein the plug cap has an opening, an end wall opposed to the opening, and cylindrical internal wall extending between the opening and the end wall.

In some aspects, the techniques described herein relate to a solar light system, wherein the cylindrical internal wall is threaded.

In some aspects, the techniques described herein relate to a solar light system, further including a seal mounted about the end wall.

In some aspects, the techniques described herein relate to a solar light system, wherein the seal is made of compressible material, and designed to be wedged or compressed (sandwiched) between the connection terminal and the plug cap when the plug cap is screwed on the connection terminal.

In some aspects, the techniques described herein relate to a solar light system, wherein the lighting device includes an energy-storage component, and wherein the splitter cable includes a diode preventing energy stored in the energy-storage component of the lighting device from flowing from the lighting device to the solar panel module.

In some aspects, the techniques described herein relate to a solar lighting kit including: a solar panel module adapted for converting solar light into electric power; a lighting device; a splitter cable adapted for connecting electrically and mechanically to the solar panel module, the splitter cable including a main power cable connecting to the solar panel module, and a number of at least two downstream cables coupled to the main power cable, each including a connection terminal adapted for connecting electrically and mechanically the lighting device thereto into a weatherproof connection powering the lighting device; and a plug cap designed to be releasably secured to any of the connection terminals to weatherproof the connection terminals.

In some aspects, the techniques described herein relate to a solar lighting kit, wherein the connection terminal and the plug cap include complementary threads.

In some aspects, the techniques described herein relate to a solar lighting kit, wherein the plug cap has an opening, an end wall opposed to the opening, and cylindrical internal wall extending between the opening and the end wall.

In some aspects, the techniques described herein relate to a solar light kit, wherein the cylindrical internal wall is threaded.

In some aspects, the techniques described herein relate to a solar light kit, further including a seal mounted about the end wall.

In some aspects, the techniques described herein relate to a solar light kit, wherein the seal is made of compressible material, the seal being designed to be wedged or compressed (sandwiched) between the connection terminal and the plug cap when screwing the plug cap on the connection terminal.

In some aspects, the techniques described herein relate to a solar lighting kit, wherein the splitter cable is permanently connected to the solar panel module.

In some aspects, the techniques described herein relate to a solar lighting kit, wherein the main power cable of the splitter cable includes a powering connection terminal, and wherein the connection terminals of the downstream cables are load connection terminals, and wherein the powering connection terminal is not identical to (that is distinct and different from) the load connection terminals.

Features and advantages of the subject matter hereof will become more apparent in light of the following detailed description of selected embodiments, as illustrated in the accompanying figures. As will be realized, the subject matter disclosed and claimed is capable of modifications in various respects, all without departing from the scope of the claims. Accordingly, the drawings and the description are to be regarded as illustrative in nature and not as restrictive and the full scope of the subject matter is set forth in the claims.

### BRIEF DESCRIPTION OF THE DRAWINGS

Further features and advantages of the present disclosure will become apparent from the following detailed description, taken in combination with the appended drawings, in which:

FIG. 1 is a schematic view of a solar lighting system in accordance with an embodiment;

FIG. 2 is a front view of a solar panel module comprising a power splitter in accordance with an embodiment;

FIGS. 3 and 4 are perspective views of the solar panel module of FIG. 2, respectively with the photovoltaic panel facing frontward and the photovoltaic panel facing away;

FIGS. 5 and 6 are a right side view and a left side view of the solar panel module of FIG. 2;

FIG. 7 a rear view of the solar panel module of FIG. 2;

FIG. 8 is another right side view of the solar panel module of FIG. 2;

FIG. 9 is a perspective view depicting a portion of the power cable of a solar module showing a splitter in accordance with an embodiment;

FIG. 10 is a perspective view depicting the end portion of the power cable of a solar panel from the splitter to the connection terminals in accordance with an embodiment;

FIG. 11 is a perspective view of a light string adapted to be powered by a solar module in accordance with an embodiment;

FIG. 12 is a front view of an exemplary lighting device comprising a solar panel in accordance with an embodiment;

FIG. 13 is a partial view of connection terminals and plug caps in accordance with an embodiment; and

FIG. 14 is a schematic of a splitter cable comprising a diode, with splitter cable being connected to a solar panel module and to a lighting device comprising a battery in accordance with an embodiment.

It will be noted that throughout the appended drawings, like features are identified by like reference numerals.

### DETAILED DESCRIPTION

The realizations will now be described more fully hereinafter with reference to the accompanying figures, in which realizations are illustrated. The foregoing may, however, be embodied in many different forms and should not be construed as limited to the illustrated realizations set forth herein.

With respect to the present description, references to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or” and so forth.

Recitation of ranges of values and of values herein or on the drawings are not intended to be limiting, referring instead individually to any and all values falling within the range, unless otherwise indicated herein, and each separate value within such a range is incorporated into the specification as if it were individually recited herein. The words “about”, “approximately”, or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the described realizations. The use of any and all examples, or exemplary language (“e.g.,” “such as”, or the like) provided herein, is intended merely to better illuminate the exemplary realizations and does not pose a limitation on the scope of the realizations. No language in the specification should be construed as indicating any unclaimed element as essential to the practice of the realizations. The use of the term “substantially” is intended to mean “for the most part” or “essentially” depending on the context. It is to be construed as indicating that some deviation from the word it qualifies is acceptable as would be appreciated by one of ordinary skill in the art to operate satisfactorily for the intended purpose.

In the following description, it is understood that terms such as “first”, “second”, “top”, “bottom”, “above”, “below”, and the like, are words of convenience and are not to be construed as limiting terms.

The terms “top”, “up”, “upper”, “bottom”, “lower”, “down”, “vertical”, “horizontal”, “interior” and “exterior” and the like are intended to be construed in their normal meaning in relation with normal installation of the product.

It should further be noted that for purposes of this disclosure, the term “coupled” means the joining of two members directly or indirectly to one another. Such joining may be stationary in nature or movable in nature and/or such joining may allow for the flow of electricity, electrical signals, or other types of signals or communication between two members. Such joining may be achieved with the two members, or the two members and any additional intermediate members, being integrally formed as a single unitary body with one another or with the two members or the two members and any additional intermediate members being attached to one another. Such joining may be permanent in nature or alternatively may be removable or releasable in nature.

In embodiments, there is disclosed a solar panel designed to power a plurality of compatible lighting devices to be installed outdoors.

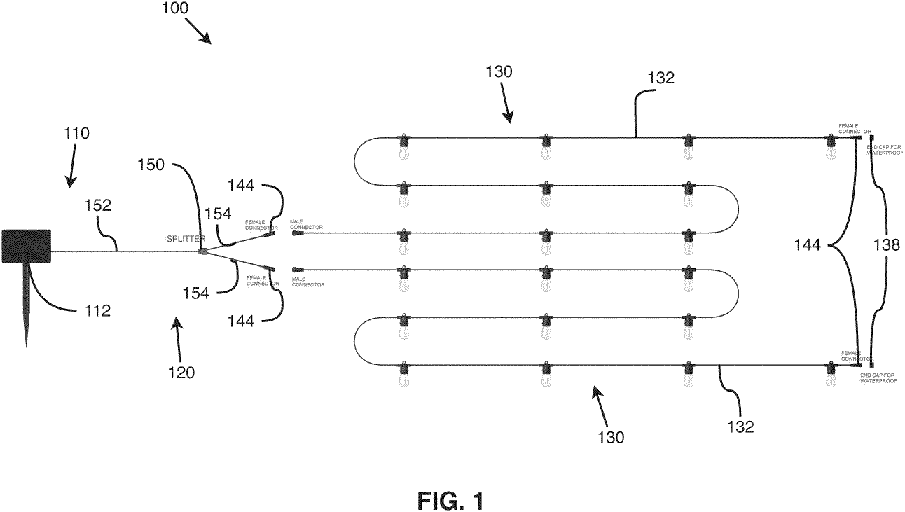

Referring now to the drawings, and more particularly to FIG. 1, the solar lighting system 100 comprises a solar panel module 110 electrically connectable to up to two lighting devices 130 using a splitter cable 120. Preferably, upon the use of a lighting device 130, such as the light string 132 is adapted both to be powered and to relay/transfer electric power. The solar lighting system 100 also comprises plug caps 138, as an exemplary embodiment of a coupling component, adapted to close connection terminals 144 and thereby to waterproof or to weatherproof connection terminals 144. The solar panel module 110 comprises a photovoltaic panel 112 adapted, upon being sunlit, to power the lighting device(s) 130 through the power cable, aka splitter cable 120, comprising a main power cable 152 connected through a splitter 150 to two downstream cables 154 having connection terminals 144, (also known as load connection terminals), at their extremity to which are connectable the lighting device(s) 130.

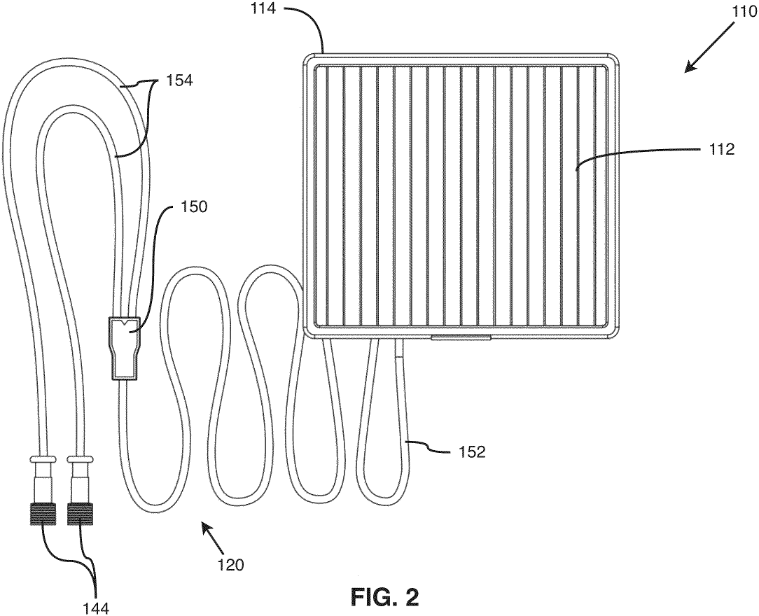

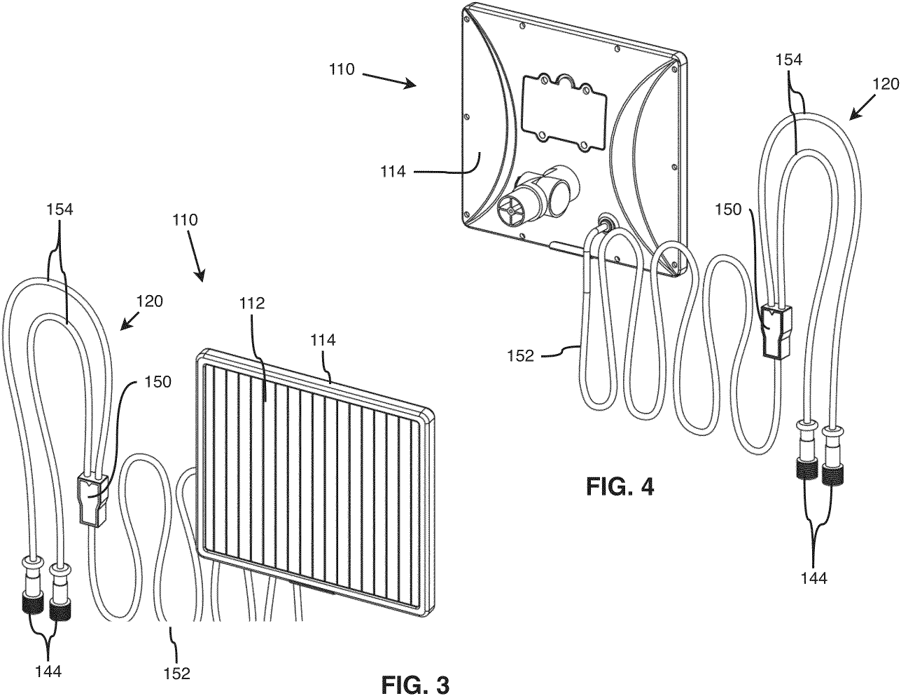

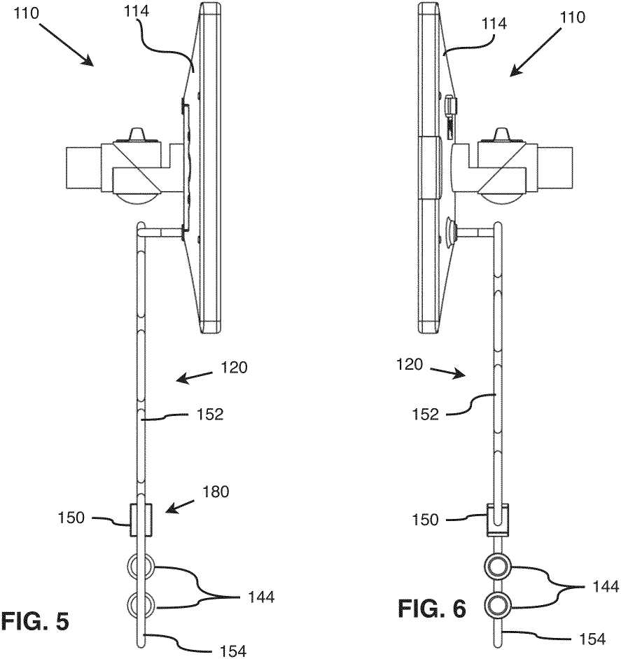

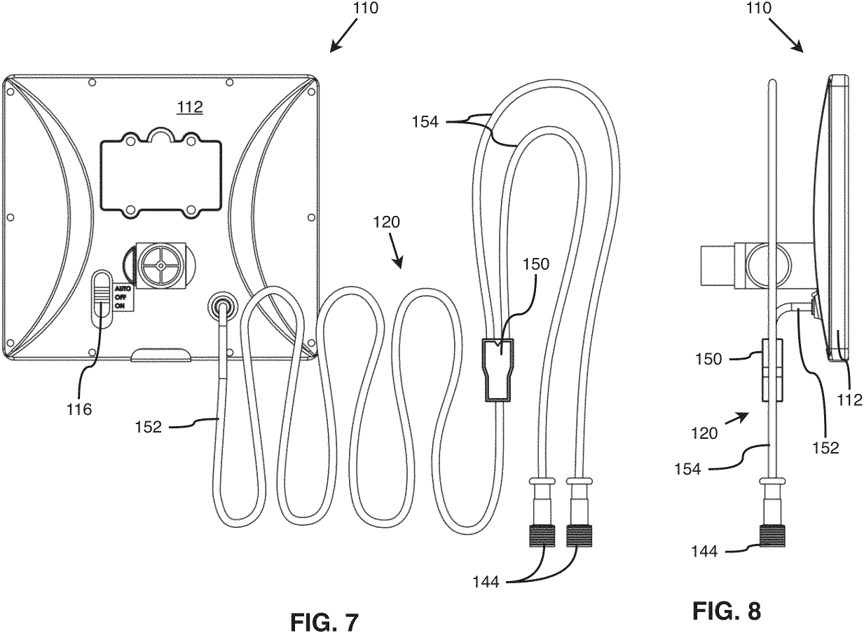

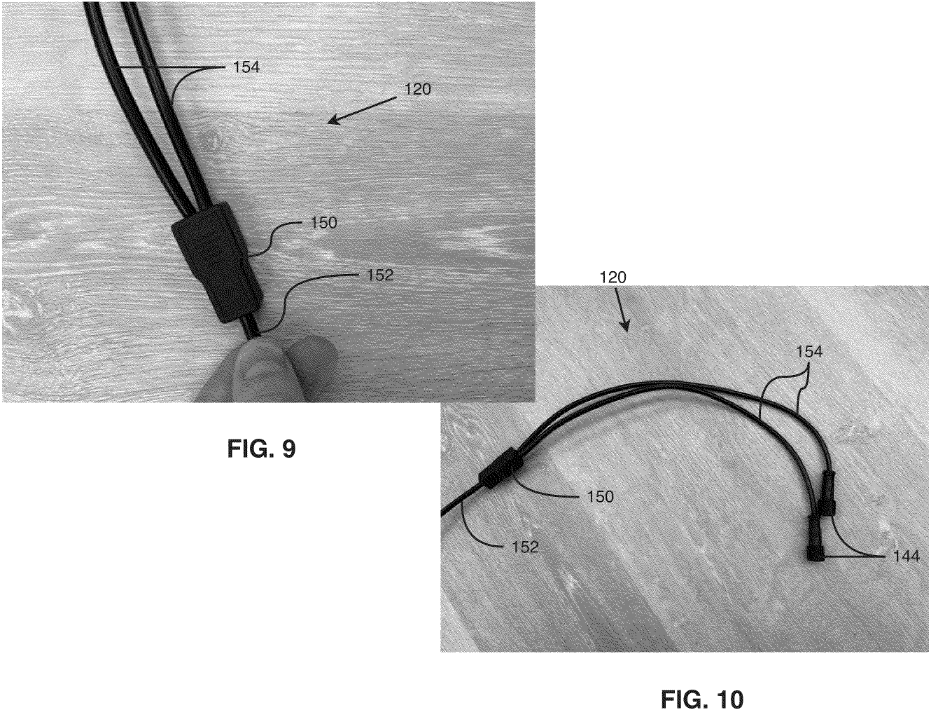

Referring additionally to FIGS. 2 to 10, the solar module comprises a casing 114 having a front where the photovoltaic panel 112 is mounted. The main power cable 152 of the splitter cable 120 extends from and is connected to the casing 114., The splitter 150 is distant from the casing is 114 and connects the main power cable 152 to the downstream cables 154 ending with connection terminals 144.

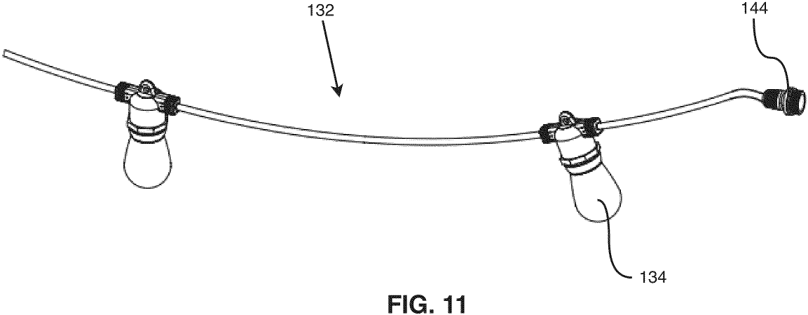

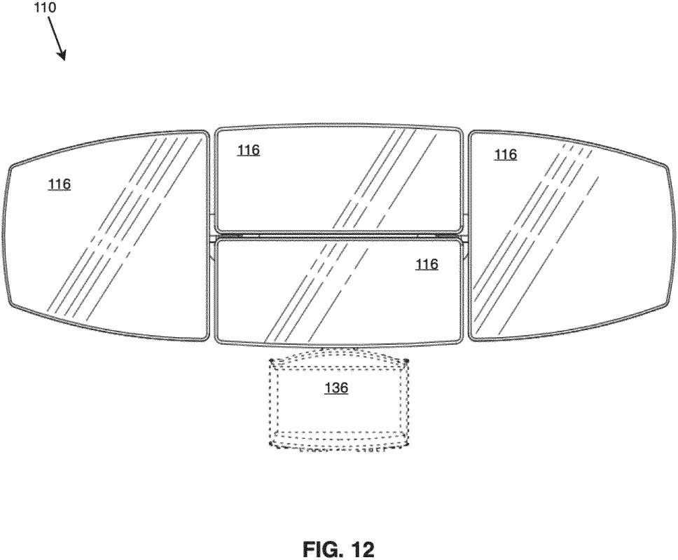

Referring to FIG. 11, there is depicted a portion of an embodiment of a lighting module, specifically a light string 132. The light string 132, which is another examplary embodiment of a coupling component, is adapted to be powered at a first one of its extremities (first connecting end) (see FIG. 1) when connected to one connection terminal 144 located at the extremity of the downstream cables 154. Light emitting components 134, e.g., Light Emitting Diode (LED), are powered along the length of the light string 132, and the light string 132 comprises at the second extremity (second connecting end) a connection terminal 144 adapted to receive either a plug cap 138 (see FIG. 1) or to connect a similar light string 132.

It is worth mentioning that in a preferred embodiment, connection terminals 144 are adapted to connect a coupling component such as a lighting device 130 using a plug and socket-type connection.

It is worth mentioning that according to embodiments the main power cable 152 may be permanently connected to e.g., the solar panel module 110 as depicted on FIG. 4, or alternatively connectable using a socket-type connection, aka a powering connection terminal, connecting it to the solar panel module 110. The latter allows increasing the electrical load to the solar panel module 110 by adding, for example, light strings 132 up to the maximum load for which the solar panel module 110 is designed.

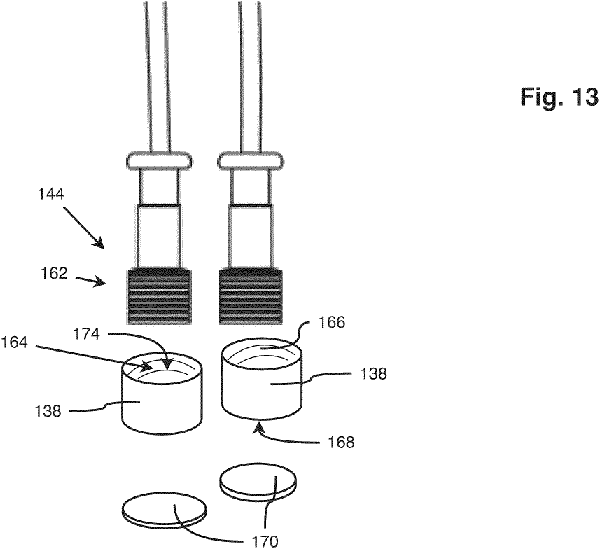

Referring additionally to FIG. 13, according to an embodiment, the plug and socket-type connection comprises threaded portions 162, 164, one component having inward threads 164 on a cylindrical internal wall 166, and the other having outward threads 162 adapted to cooperate with the inward thread 164 when connecting the connection terminals 144 (i.e., one is a male connector and the other is a female connector). Once the threads are screwed over each other, the connection therebetween is weatherproofed, including waterproofed.

Similarly, connection between the connection terminals 144 and the plug cap 138 are performed the same way. The plug cap 138 defines an enclosure adapted to temporarily seal the connection terminals 144, rendering it weatherproof.

According to a first embodiment, the plug cap 138 typically has an internal cylindrical threaded face 164 adapted to interface with the connection terminal 144. The plug cap 138 has an end wall 168 opposed to its opening 174 that closes the space within the plug cap 138 other than the opening 174. A compressible seal 170, shaped either as a disk or a torus, is inserted in the plug cap 138. The compressible seal 170, when screwing the plug cap 138 over the connection terminal 144, is wedged or compressed (sandwiched) between the edge of the connection terminals 144 and the closed wall 168, temporarily sealing the connection terminal 144.

According to embodiments, the connection terminals 144 and the plug cap 138 may feature alternative securing parts. For example, the alternative securing parts could include deformable non-smooth surface(s) preventing the plug cap 138 to be removed unless a force is exerted thereon in a direction away from the connection terminals 144 (said force being greater than a deformation force threshold). In another example, the alternative securing parts could include a mortise-and-tenon type of interface comprising one or more channels, and complementary protrusions adapted to be respectively inserted in the channels and to lock in the channels at a locking position when a force is exerted to compress the seal 170, to place the protrusion(s) in the locking position and to release the force.

Thus, according to embodiments, embodiments of solar panel module 110 may be adapted to performed more than one function among
converting solar light into electric power;
stocking electric power;
lighting up its vicinity; and
managing the distribution of electric power to connected lighting modules.

It is worth mentioning that it is further contemplated the use of a splitter cable 120 be permanently connected to the casing 114, or a splitter cable 120 releasably connected to the casing 114 using e.g., a plug and socket -type connection.

According to another embodiment (not shown), another splitter cable is connected to one of the connection terminals 144 of the splitter cable 120 which is connected to the photovoltaic panel 112. The addition of another splitter cable therefore the connection and powering of three lighting devices 130.

According to yet another embodiment (not shown), the splitter 150 connects more than two downstream cables 154 to the main power cable 152 and thereby split the electrical power accordingly.

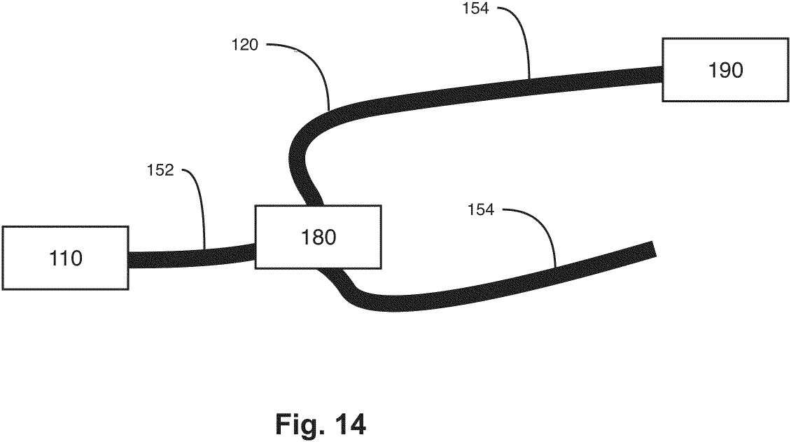

Referring to FIG. 14, according to an embodiment, the splitter cable 120 comprises a diode 180 allowing the splitter 120 to be connected to a lighting device 190 comprising a battery. According to an embodiment, the splitter cable 120 has a main power cable 152 and downstream cables 154, with power being designed to travel from a power source, e.g., solar panel module 110, connected to the main power cable 152, to the downstream cables 154. When the lighting device 190 is connected thereto, and the solar panel module 110 generates enough energy to charge the batteries of both the solar panel module 110 and the power storage component of the lighting device 190, current flows from the solar panel module 110 to the lighting device 190. As soon as the energy generated/stored by the solar panel module 110 decreases below the energy stored in the battery (power storage component) of the lighting device 190, energy generated by the solar panel module 110 is stored locally (battery of the solar panel module 110). Upon the lighting device 190 depleting its stored energy below the energy stored in the solar panel module 110, current starts again flowing from the solar panel module 110 to the lighting device 190. Accordingly, the splitter cable 120 virtually provided a distributed power storage (in the lighting device 190 and in the solar panel module 110) without having a risk of countercurrent damaging the solar panel module 110.

### Installation of the Solar Lighting System

Installation of the solar lighting system 100 typically comprises the step of installing the solar panel module 110 at a sunlit location with the photovoltaic panel 112 generally facing the sun. According to embodiments, installing the 110 may comprise sticking the solar panel module 110 on the ground, or mounting the solar panel module 110 on a structure using appropriate mounting means (included or not with the solar panel module 110). Installing the solar panel module 110 may further comprise orienting the photovoltaic panel 112 e.g., toward the south, and adjusting the slope of the photovoltaic panel 112 to optimize the sunlight reaching the photovoltaic panel 112 and the efficacy of the sunlight reaching the photovoltaic panel 112.

Once the solar panel module 110 is installed, the installation comprises to run the main power cable 152 toward the general location of the e.g., lighting devices 130 and passed the splitter 150, to individually run the downstream cables 154 respectively toward each of the (directly powered) lighting devices 130.

The installation comprises when plug caps 138 are mounted to the connection terminals 144, for each of the connection terminals 144 to be connected to a lighting device 130, e.g., unscrewing the plug cap 138 from the connection terminal 144, and screwing the inlet connector of the lighting device 130 to the connection terminal 144.

When a single one of the connection terminals 144 is to be connected to a lighting device 130, the installation comprises keeping the plug cap 138 screwed to the unused connection terminal 144 to keep them protected from the weather.

Alternatively, if no plug cap 138 is initially screwed on the connection terminals 144, the installation comprises screwing a plug cap 138 on the unused connection terminal 144 thereby weatherproofing the connection terminal 144.

Afterwards, the installation comprises installing the connected lighting device(s) 130 by e.g., hanging the lighting device 130 at appropriate locations(s).

The installation may also comprise confirming that the connection terminal 144 at the opposed end of the (directly powered) lighting device 130 has a plug cap 138 screwed thereto, and if no plug cap is screwed, taking the plug cap 138 unscrewed from the connection terminal 144 of the solar panel module 110 and screwing it to the connection terminal of the lighting device 130.

Alternatively, the installation may comprise repeating the steps of installing the lighting device 130 to the (directly powered) lighting device 130. The installation of the lighting devices in a chain may be repeated as long as the power consumption of the sum of the lighting devices 130, aka of the sum of the two chains, remains under the maximum power consumption rating of the solar lighting system 100, or e.g., based on wiring capacity of the lighting devices 130.

Preferably, according to embodiments, the load exerted by the chains of lighting devices 130 connected to the first connection terminals 144 and to the second connection terminals 144 is substantially balanced. In other words, the selection of lighting devices 130 composing the chains is performed to limit the difference of power consumption between the first chain and the second chain of lighting device(s) 130.

While preferred embodiments have been described above and illustrated in the accompanying drawings, it will be evident to those skilled in the art that modifications may be made without departing from this disclosure. Such modifications are considered as possible variants comprised in the scope of the disclosure.

1. A solar lighting system comprising:
a solar panel module adapted for converting solar light into electric power;
a splitter cable electrically and mechanically connected to the solar panel module, the splitter cable comprising a main power cable connecting to the solar panel module, and at least two downstream cables coupled to the main power cable, each comprising a connection terminal adapted for connecting electrically and mechanically to a lighting device to be powered therethrough,
wherein the connection terminals feature a securing part designed for interfacing with a coupling component into a weatherproof connection.

2. The solar lighting system of claim 1, wherein the splitter cable is permanently connected to the solar panel module.

3. The solar lighting system of claim 1, wherein the main power cable of the splitter cable comprises a powering connection terminal.

4. The solar light system of claim 3, wherein the connection terminals of the downstream cables are load connection terminals, and wherein the powering connection terminal are distinct and different from the load connection terminals.

5. The solar light system of claim 1, further comprising the lighting device, the lighting device comprising a connection terminal that can be secured to one of the connection terminals to connect electrically and mechanically the lighting device to the solar panel module.

6. The solar light system of claim 1, further comprising a plug cap securable to the connection terminals to weatherproof the connection terminal therethrough.

7. The solar light system of claim 6, wherein the connection terminal and the plug cap comprise complementary threads.

8. The solar light system of claim 7, wherein the plug cap has an opening, an end wall opposed to the opening, and cylindrical internal wall extending between the opening and the end wall.

9. The solar light system of claim 8, wherein the cylindrical internal wall is threaded.

10. The solar light system of claim 8, further comprising a seal mounted about the end wall.

11. The solar light system of claim 10, wherein the seal is made of compressible material, and designed to be compressed between the connection terminal and the plug cap when the plug cap is screwed on the connection terminal.

12. The solar light system of claim 1, wherein the lighting device comprises an energy-storage component, and wherein the splitter cable comprises a diode preventing energy stored in the energy-storage component of the lighting device from flowing from the lighting device to the solar panel module.

13. A solar lighting kit comprising:
a solar panel module adapted for converting solar light into electric power;
a lighting device;
a splitter cable adapted for connecting electrically and mechanically to the solar panel module, the splitter cable comprising a main power cable connecting to the solar panel module, and a number of at least two downstream cables coupled to the main power cable, each comprising a connection terminal adapted for connecting electrically and mechanically the lighting device thereto into a weatherproof connection powering the lighting device; and
a plug cap designed to be releasably secured to any of the connection terminals to weatherproof the connection terminals.

14. The solar lighting kit of claim 13, wherein the connection terminal and the plug cap comprise complementary threads.

15. The solar lighting kit of claim 14, wherein the plug cap has an opening, an end wall opposed to the opening, and cylindrical internal wall extending between the opening and the end wall.

16. The solar light kit of claim 15, wherein the cylindrical internal wall is threaded.

17. The solar light kit of claim 15, further comprising a seal mounted about the end wall.

18. The solar light kit of claim 17, wherein the seal is made of compressible material, the seal being designed to be compressed between the connection terminal and the plug cap when screwing the plug cap on the connection terminal.

19. The solar lighting kit of claim 13, wherein the splitter cable is permanently connected to the solar panel module.

20. The solar lighting kit of claim 13, wherein the main power cable of the splitter cable comprises a powering connection terminal, and wherein the connection terminals of the downstream cables are load connection terminals, and wherein the powering connection terminal is not identical to the load connection terminals.
